(19) United States
(12) Patent Application Publication
(10) Pub. No.: US 2007/0039176 A1
(43) Pub. Date: Feb. 22, 2007

(54) Method for restoring portion of turbine component

(76) Inventor: Thomas Joseph Kelly, Cincinnati, OH (US)

Correspondence Address: JAGTIANI + GUTTAG, 10363-A DEMOCRACY LANE, FAIRFAX, VA, 22030, US

(21) Appl. No.: 11/193,389

(22) Filed: Aug. 1, 2005

(51) Int. Cl. B23P 6/00; B23P 19/04

(52) U.S. Cl. 29/889.1; 29/402.09; 29/402.13

(57) ABSTRACT

A method for restoring a removed portion of the airfoil wall of a turbine component. This method comprises the following steps: (a) providing a turbine component comprising an airfoil having a metal substrate with a wall thickness, wherein a portion of the wall thickness has been removed so as to provide a residual wall thickness; (b) providing a metal composition that at least substantially matches that of the residual wall thickness; and (c) applying the metal composition to the residual wall thickness such that the metal composition: (1) is adhered to the residual wall thickness; and (2) at least substantially restores the removed wall thickness. Also provided is a method for restoring a removed portion of the airfoil wall of a previously repaired turbine component.

### BACKGROUND OF THE INVENTION

This invention broadly relates to a method for restoring a removed portion of the airfoil wall of a turbine component.

Higher operating temperatures of gas turbine engines are continuously sought in order to increase their efficiency. However, as operating temperatures increase, the high temperature durability of the components of the engine must correspondingly increase. While significant advances in high temperature capabilities have been achieved through formulation of nickel and cobalt-base superalloys, such alloys alone are often inadequate to form turbine components located in certain sections of a gas turbine engine, turbine shrouds, buckets, nozzles, combustion liners and deflector plates, augmentors and the like. A common solution is to thermally insulate such components, e.g., turbine blades, vanes, etc., in order to minimize their service temperatures. For this purpose, thermal barrier coatings have been applied over the metal substrate of turbine components exposed to such high surface temperatures.

Thermal barrier coatings typically comprise a ceramic layer that overlays a metal substrate comprising a metal or metal alloy. Various ceramic materials have been employed as the ceramic layer, for example, chemically (metal oxide) stabilized zirconias such as yttria-stabilized zirconia, scandia-stabilized zirconia, calcia-stabilized zirconia, and magnesia-stabilized zirconia. The thermal barrier coating of choice is typically a yttria-stabilized zirconia ceramic coating, such as, for example, about 7% yttria and about 93% zirconia.

In order to promote adhesion of the ceramic layer to the underlying metal substrate and to prevent oxidation thereof, a bond coat layer is typically formed on the metal substrate from an oxidation-resistant overlay alloy coating such as MCrAlY where M can be iron, cobalt and/or nickel, or from an oxidation-resistant diffusion coating such as an aluminide, for example, nickel aluminide and platinum aluminide. Depending upon the bond coat layer used, the thermal barrier coating can be applied on the bond coat layer by either by thermal spray techniques, such as plasma spray, or by physical vapor deposition (PVD) techniques, such as electron beam physical vapor deposition (EB-PVD).

In certain instances, the turbine component simply requires environmental protection from the oxidizing atmosphere of the gas turbine engine, as well as other corrosive agents that are present. For example, turbine components such as turbine blades, vanes, etc., can be susceptible to oxidation or other corrosion problems when operating in certain sections of the gas turbine engine. In such instances, a diffusion coating such as a platinum aluminide, nickel aluminide or simple aluminide coating can be applied to the metal substrate. Such diffusion coatings are typically capable of resisting oxidation, or other corrosive effects that occur during gas turbine engine operation.

Though significant advances have been made in improving the durability of thermal barrier coatings, as well as diffusion coatings used for environmental protection, such coatings will typically require removal and repair under certain circumstances. For example, thermal barrier coatings, as well as diffusion coatings, can be susceptible to various types of damage, including objects ingested by the engine, erosion, oxidation, and attack from environmental contaminants that will require removal and repair of the coating. Removal of the coating may also be necessitated during turbine component manufacture because of defects in the coating, handling damage and the need to repeat noncoating-related manufacturing operations which require removal of the coating, e.g., electrical discharge machining (EDM) operations, etc.

In removing a thermal barrier coatings, as well as protective diffusion coatings, abrasive procedures such as grit blasting, vapor honing and glass bead peening typically used. In such abrasive procedures, the bond coat layer of the thermal barrier coating is typically removed, along with some of the underlying metal substrate. Similarly, in removing diffusion coatings, some of the underlying metal substrate is also typically removed. Removal of the underlying metal substrate is particularly acute with diffusion coatings and diffusion bond coat layers because such coatings/layers diffuse and extend into the metal substrate surface. See commonly assigned U.S. Pat. No. 6,238,743 (Brooks), issued May 29, 2001 (use of aqueous solution of ammonium bifluoride to remove ceramic coating without degrading bond coat); U.S. Pat. No. 6,379,749 (Zimmerman, Jr. et al.), issued Apr. 30, 2002 (use of aqueous solution of ammonium bifluoride or sodium bifluoride to remove ceramic coating without damaging underlying substrate material); and U.S. Patent Application No. 2003/0116237 (Worthing, Jr. et al.), published Jun. 26, 2003 (rejuvenation of diffusion aluminide coating using of aqueous solution of nitric acid and phosphoric acid to remove part of additive layer but not diffusion zone of diffusion aluminide coating before re-aluminizing).

In the case of certain turbine components such as turbine blades, vanes, etc., that comprise airfoils from which such coatings have been removed, the wall thickness of the airfoil becomes thinner because of the removal of a portion of the metal substrate. As the coating is removed additional times for repair thereof, the wall thickness of the airfoil typically becomes progressively thinner as more of the metal substrate is removed. Indeed, the wall thickness of the airfoil can become so thin that the turbine blade, vane, etc., is no longer useable and must therefore be scrapped or discarded. See commonly assigned U.S. Patent Application No. 2003/0116237 (Worthing, Jr. et al.), published Jun. 26, 2003.

Accordingly, it would be desirable to be able to be able to repair such coatings for gas turbine engine components without having decreasing wall thicknesses of the airfoil become so acute as to require scrapping or discarding of the turbine component.

### BRIEF DESCRIPTION OF THE INVENTION

An embodiment of this invention is broadly directed at a method comprising the following steps:
(a) providing a turbine component comprising an airfoil having a metal substrate with a wall thickness, wherein a portion of the wall thickness has been removed so as to provide a residual wall thickness;
(b) providing a metal composition that at least substantially matches that of the residual wall thickness; and
(c) applying the metal composition to the residual wall thickness such that the metal composition:
   (1) is adhered to the residual wall thickness; and
   (2) at least substantially restores the removed wall thickness.

Another embodiment of this invention is broadly directed at a method comprising the following steps:
(a) providing a previously repaired turbine component comprising an airfoil having a metal substrate with a wall thickness, wherein a portion of the wall thickness has been removed so as to provide a residual wall thickness;
(b) providing a metal composition that at least substantially matches that of the residual wall thickness; and
(c) applying the metal composition to the residual wall thickness such that the metal composition:
   (1) is adhered to the residual wall thickness; and
   (2) at least substantially restores the removed wall thickness.

The embodiments of the method of this invention provide a number of advantages and benefits with regard to restoring the wall thickness of airfoils, and in particular, repaired airfoils of turbine components. For example, the ability to be able to effectively restore the removed wall thickness of the repaired airfoil permits repair of protective coatings on such airfoils a plurality of times without adversely affecting the mechanical or other properties (e.g., mechanical strength) of the turbine component comprising the airfoil. The ability to be able to effectively restore the wall thickness of the repaired airfoil also avoids having to dispose of repaired turbine component (e.g., turbine blade) because of an insufficient wall thickness.

### BRIEF DESCRIPTION OF THE DRAWINGS

FIG. 1 is a perspective view of a turbine blade for which the method of this invention is useful.

FIG. 2 is a sectional view of the blade of FIG. 1 prior to restoration of the removed airfoil wall thickness according to an embodiment of the method of this invention.

FIG. 3 is a sectional view of the blade of FIG. 1 after restoration of the removed airfoil wall thickness according to an embodiment of the method of this invention.

FIG. 4 is an image showing a side sectional view of an airfoil of a turbine blade prior to restoration of the removed airfoil wall thickness according to an embodiment of the method of this invention.

FIG. 5 is an image showing a side sectional view of an airfoil of a turbine blade after restoration of the removed airfoil wall thickness according to an embodiment of the method of this invention.

### DETAILED DESCRIPTION OF THE INVENTION

As used herein, the term “wall thickness” refers to the total thickness of the metal substrate in the wall of the airfoil.

As used herein, the term “repair area” refers to that area of the airfoil from which a coating, such as a diffusion coating, is removed, in whole or in part.

As used herein, the term “removed wall thickness” refers to that portion of the wall thickness of the metal substrate that is removed when the coating, such as a diffusion coating, is removed.

As used herein, the term “residual wall thickness” refers to that portion of the wall thickness of the metal substrate that remains after removal of the portion of the wall thickness.

As used herein, the term “adhered to the residual wall thickness” refers to the applied metal composition becoming combined with, integral with, attached to or otherwise adhered to the residual wall thickness. Typically, the applied metal composition becomes integral with or substantially integral with the residual wall thickness.

As used herein, the term “at least substantially restores the removed wall thickness” refers to restoring the removed wall thickness so that the metal substrate in the airfoil has a wall thickness that is the same or substantially the same as that prior to removal of the portion of the wall thickness.

As used herein, the term “previously repaired turbine component” refers to a turbine component that has been repaired one or more times (i.e., a plurality of times), for example, by removing a protective coating (e.g., a thermal barrier coating, etc.), removing a diffusion coating, etc., such that the wall thickness of the airfoil portion of the metal substrate has been removed one or more times.

As used herein, the term “is matched or substantially matched” means that the metal composition matches or substantially matches the nominal alloy composition (e.g., within the normal specification limits of the alloy) of the residual wall thickness of the metal substrate. By matching or substantially matching the nominal alloy composition of the residual wall thickness of the metal substrate, the metal composition used in restoring the removed wall thickness has greater chance to become adhere to, and especially to become integral or substantially integral with, the residual wall thickness of the metal substrate.

As used herein, the term “high gamma-prime nickel alloy” typically refers to a nickel having more than about 5% aluminum or more than about 6% combined aluminum and titanium.

As used herein, the term “single crystal alloy” refers in the conventional sense to a metal alloy having no grain boundaries and a crystalline morphology.

As used herein, the term “directionally solidified alloy” refers in the conventional sense to a metal alloy having a directional grain boundary and a crystalline morphology.

As used herein, the term “equiaxed alloy” refers in the conventional sense to a metal alloy having a plurality of grain boundaries and a crystalline morphology.

As used herein, the term “diffusion coating” refers to coatings deposited by diffusion techniques and typically containing various noble metal aluminides such as nickel aluminide and platinum aluminide, as well as simple aluminides (i.e., those formed without noble metals). These diffusion coatings are typically formed on metal substrates by chemical vapor phase deposition (CVD), pack cementation techniques, etc. See, for example, U.S. Pat. No. 4,148,275 (Benden et al.), issued Apr. 10, 1979; U.S. Pat. No. 5,928,725 (Howard et al.), issued Jul. 27, 1999; and U.S. Pat. No. 6,039,810 (Mantkowski et al.), issued Mar. 21, 2000 (the relevant portions of each of which are incorporated by reference), which disclose various apparatus and methods for applying aluminide diffusion coatings by CVD.

As used herein, the term “comprising” means various compositions, compounds, components, ingredients, coatings, substrates, layers, steps, etc., can be conjointly employed in this invention. Accordingly, the term “comprising” encompasses the more restrictive terms “consisting essentially of” and “consisting of.”

All amounts, parts, ratios and percentages used herein are by weight unless otherwise specified.

The embodiments of the method of this invention are based on the discovery that the removed wall thickness of the airfoil portion of a turbine component such as a turbine blade, turbine vane, turbine nozzle, etc., can be restored so that the turbine component comprising the airfoil can be reused. For example, in removing a diffusion coating for the purpose of the repairing that diffusion coating, or for repairing an overlaying protective coating such as a thermal barrier coating, a portion of the wall thickness of the underlying metal substrate is also typically removed. Previously, the diffusion coating or other coating was reapplied without restoring this removed wall thickness of the metal substrate of the airfoil. Especially after the diffusion coating has been removed several (i.e., a plurality of) times, the residual wall thickness of the metal substrate of the airfoil typically becomes progressively thinner, until the residual wall thickness is so thin that the turbine component is no longer useable, and has to be scrapped or otherwise discarded. Optionally, the diffusion coating may be removed by special techniques (e.g., by use of special stripping solutions) that avoid or substantially avoid removing the underlying metal substrate. See commonly assigned U.S. Pat. No. 6,238,743 (Brooks), issued May 29, 2001 (use of aqueous solution of ammonium bifluoride to remove ceramic coating without degrading bond coat); U.S. Pat. No. 6,379,749 (Zimmerman, Jr. et al.), issued Apr. 30, 2002 (use of aqueous solution of ammonium bifluoride or sodium bifluoride to remove ceramic coating without damaging underlying substrate material); and U.S. Patent Application No. 2003/0116237 (Worthing, Jr. et al.), published Jun. 26, 2003 (rejuvenation of diffusion aluminide coating using of aqueous solution of nitric acid and phosphoric acid to remove part of additive layer but not diffusion zone of diffusion aluminide coating before re-aluminizing).

The embodiments of the method of this invention solve these problems caused by the need to at least periodically remove the diffusion coating by effectively restoring this removed wall thickness of the metal substrate of the airfoil in the repair area. In restoring, or substantially restoring the removed wall thickness of the airfoil in the repair area, the metal composition of the residual wall thickness of the metal substrate is matched or substantially matched such that the metal composition is more likely to become adhered to, and especially to become integral with, the residual wall thickness of the airfoil. The metal composition is applied in an amount sufficient to restore or substantially restore the removed wall thickness of the metal substrate in the repair area of the airfoil. The metal composition may also be applied by a technique (e.g., physical vapor deposition) that enables the metal composition to adhere to the residual wall thickness of the metal substrate, and typically become integral, or substantially integral, therewith. The ability to be able to effectively restore the removed wall thickness of the repaired airfoil by embodiments of the method of this invention permits, for example, the repair of the protective coatings on such airfoils multiple times without adversely affecting the mechanical or other properties (e.g., mechanical strength) of the turbine component comprising the airfoil. In particular, the ability to be able to effectively restore the wall thickness of the repaired airfoil avoids having to dispose of repaired turbine component (e.g., turbine blade) because of an insufficient wall thickness, which can be expensive.

The embodiments of the method of this invention are useful in restoring the removed wall thickness of airfoils for any turbine engine (e.g., gas turbine engine) component that comprises an airfoil. These turbine components that comprise airfoils can include turbine blades, turbine vanes, turbine nozzles, turbine blisks, etc. While the following discussion of an embodiment of the method of this invention will be with reference to turbine blades, and especially the airfoil portions thereof that comprise these blades, it should also be understood that the method of this invention can be useful with other turbine components (e.g., the liners, flaps and seals of exhaust nozzles) that comprise airfoils and require repair of removed wall thicknesses of the airfoil.

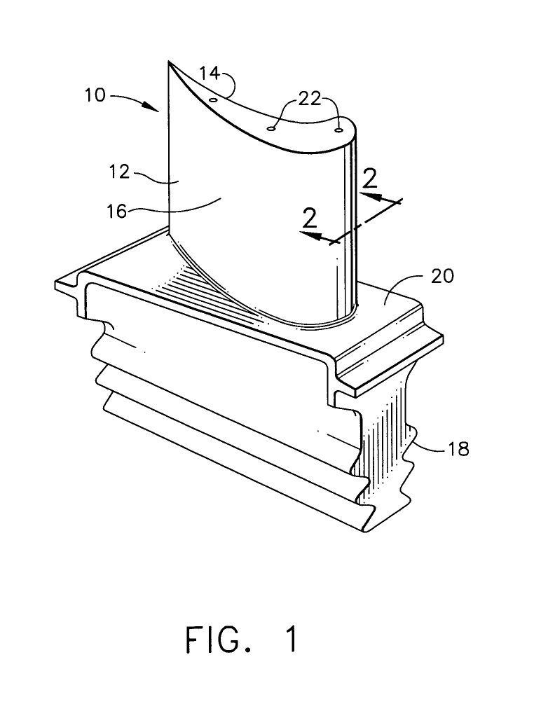

The various embodiments of this invention are further illustrated by reference to the drawings as described hereafter. Referring to the drawings, FIG. 1 depicts a component article of a gas turbine engine such as a turbine blade or turbine vane, and in particular a turbine blade identified generally as 10. (Turbine vanes have a similar appearance with respect to the pertinent portions.) Blade 10 generally includes an airfoil 12 against which hot combustion gases are directed during operation of the gas turbine engine, and whose surfaces are therefore subjected to high temperature environments. Airfoil 12 has a “high-pressure side” indicated as 14 that is concavely shaped; and a suction side indicated as 16 that is convexly shaped and is sometimes known as the “low-pressure side” or “back side.” In operation the hot combustion gas is directed against the high-pressure side 14. Blade 10 is anchored to a turbine disk (not shown) with a dovetail 18 that extends downwardly from the platform 20 of blade 10. In some embodiments of blade 10, a number of internal passages extend through the interior of airfoil 12, ending in openings indicated as 22 in the surface of airfoil 12. During operation, a flow of cooling air is directed through the internal passages (not shown) to cool or reduce the temperature of airfoil 12.

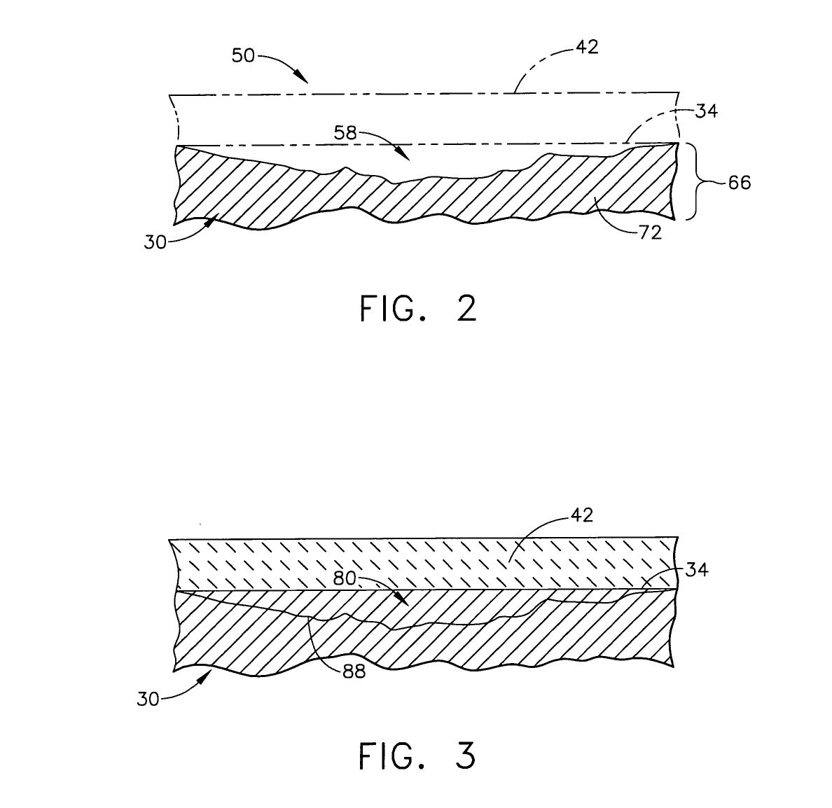

Referring to FIG. 2, the metal substrate of airfoil 12 is indicated generally as 30 and is shown as having a surface 34. Substrate 30 can comprise any of a variety of metals, or more typically metal alloys, including those based on nickel, cobalt and/or iron alloys. Substrate 30 typically comprises a superalloy based on nickel, cobalt and/or iron. Suitable superalloys may have single crystal, directionally solidified or equiaxed morphologies. Such superalloys are disclosed in various references, such as, for example, commonly assigned U.S. Pat. No. 6,074,602 (Wukusick et al.), issued Jun. 13, 2000; U.S. Pat. No. 6,444,057 (Darolia et al.), issued Sep. 3, 2002; and U.S. Pat. No. 6,905,559 (O'Hara et al.), issued Jun. 14, 2005, the relevant portions of each of which are incorporated by reference. Superalloys are also generally described in Kirk-Othmer's Encyclopedia of Chemical Technology, 3rd Ed., Vol. 12, pp. 417-479 (1980), and Vol. 15, pp. 787-800 (1981). Illustrative nickel-based superalloys suitable for use herein are designated by the trade names Inconel®, Nimonic®, Rene®, e.g., Rene® 142 and N4, directionally solidified alloys, Rene® N5 and N6 single crystal alloys, and Rene® 80 and 125 equiaxed alloys. The embodiments of the method of this invention are particularly useful for restoring the wall thickness of high pressure turbine blades 10 comprising high gamma-prime nickel alloys that are exposed to the hottest, most hostile environments of a gas turbine engine.

Typically overlaying surface 34 of metal substrate 30 is a protective coating, such as a diffusion coating indicated generally as 42, with or without an additional protective coating such as an overlaying thermal barrier coating (TBC), wherein diffusion coating 42 functions essentially as a bond coat layer to improve adherence of the TBC to surface 34 of substrate 30. Over time and during normal engine operation, diffusion coating 42 will need to be removed because the overlaying TBC, or diffusion coating 42, itself has become worn out or damaged, e.g., by foreign objects ingested by the engine, erosion, oxidation, as well as attack from environmental contaminants. In an embodiment of the method of this invention, there is an initial step that involves stripping off, or otherwise removing diffusion coating 42 (and any overlaying TBC) from metal substrate 30. Diffusion coating 42 can be removed by any suitable method known to those skilled in the art for removing diffusion coatings. Methods for removing such diffusion coatings 42 can be by mechanical removal, chemical removal, or any combination thereof. Suitable removal methods include grit blasting, with or without masking of surfaces that are not to be subjected to grit blasting (see commonly assigned U.S. Pat. No. 5,723,078 to Niagara et al., issued Mar. 3, 1998, especially col. 4, lines 46-66, which is incorporated by reference), micromachining, laser etching (see commonly assigned U.S. Pat. No. 5,723,078 to Niagara et al., issued Mar. 3, 1998, especially col. 4, line 67 to col. 5, line 3 and 14-17, which is incorporated by reference), treatment (such as by photolithography) with chemical etchants for diffusion coating 42 such as those containing hydrochloric acid, hydrofluoric acid, nitric acid, ammonium bifluorides and mixtures thereof, (see, for example, commonly assigned U.S. Pat. No. 5,723,078 to Nagaraj et al., issued Mar. 3, 1998, especially col. 5, lines 3-10; U.S. Pat. No. 4,563,239 to Adinolfi et al., issued Jan. 7, 1986, especially col. 2, line 67 to col. 3, line 7; U.S. Pat. No. 4,353,780 to Fishter et al., issued Oct. 12, 1982, especially col. 1, lines 50-58; and U.S. Pat. No. 4,411,730 to Fishter et al., issued Oct. 25, 1983, especially col. 2, lines 40-51, the relevant disclosures of each of which are incorporated by reference), treatment with water under pressure (i.e., water jet treatment), with or without loading with abrasive particles, as well as various combinations of these methods. Typically, diffusion coating 42 is removed by grit blasting wherein diffusion coating 42 is subjected to the abrasive action of silicon carbide particles, steel particles, alumina particles or other types of abrasive particles. These particles used in grit blasting are typically alumina particles and typically have a particle size of from about 220 to about 35 mesh (from about 63 to about 500 micrometers), more typically from about 80 to about 60 mesh (from about 180 to about 250 micrometers).

Referring to FIG. 2, in removing diffusion coating 42 from a repair area of airfoil 12 indicated generally as 50, typically a portion of the wall thickness of metal substrate 30 is removed, as indicated generally by 58. Because of the removed portion of wall thickness 58 of metal substrate 30, the total wall thickness of the metal substrate 30 generally indicated as 66 is decreased, thus leaving a residual portion of wall thickness of metal substrate 30 indicated generally as 72. If diffusion coating 42 is removed several times, the removed wall thickness 58 typically increases, leaving behind less and less of the residual wall thickness 72 of metal substrate 30. Eventually, the residual wall thickness 72 of metal substrate 30 becomes so thin that blade 10 is no longer useable, and will have to be scrapped or otherwise discarded.

To avoid the need to scrap or otherwise discard blade 10, an embodiment of the method of this invention restores all, or substantially all of the removed wall thickness 58 in repair area 50 before diffusion coating 42 is reapplied to surface 34 of substrate 30. The removed wall thickness 50 of the repair area 58 of substrate 30 is restored by matching or substantially matching the metal composition of the metal alloy present in residual wall thickness 72 of substrate 30.

Referring to FIG. 3, the metal composition used in restoring the removed wall thickness 58 is applied to the repair area 58 of substrate 30 in an amount sufficient to restore all, or substantially all, of the removed wall thickness 58, as indicated by 80, using any suitable physical vapor deposition (PVD) technique for applying the metal composition to repair area 50. Suitable PVD techniques are those that deposit from a vapor or ionic phase directly, and not from a liquid or solid phase, such that interfacial boundaries are minimized between the metal substrate and the deposited metal composition. Suitable PVD techniques include electron beam physical vapor deposition (EBPVD), cathodic arc, ion plasma, pulsed laser deposition (PLD), etc., as well as combinations of such PVD techniques, including combinations of EBPVD with cathodic arc, EBPVD with ion plasma, EBPVD with sputtering, EBPVD with PLD, sputtering with PLD, cathodic arc with PLD, etc. See, for example, U.S. Pat. No. 5,645,893 (Rickerby et al.), issued Jul. 8, 1997 (especially col. 3, lines 36-63) and U.S. Pat. No. 5,716,720 (Murphy), issued Feb. 10, 1998) (especially col. 5, lines 24-61) (the relevant portions each of which are incorporated by reference), which disclose various apparatus and methods for applying metal compositions according to the embodiments of the method of this invention by PVD techniques, including EB-PVD techniques.

After metal composition is applied to the repair area 50 of the residual wall thickness 72 of substrate 30, the applied metal composition of restored wall thickness 80 is then heat treated so that it adheres, at the interface indicated generally as 88, to residual wall thickness 72 of metal substrate 30, and typically becomes integral or substantially integral therewith. Typically, the applied metal composition is heat treated to make it integral with the residual wall thickness 72 of substrate 30, such as by induction heating to avoid heating other portions of blade 10 such as dovetail 18, as well as to avoid affecting internal coatings applied to airfoil 12, such as those applied to the internal cooling passages (not shown). In addition to induction heating, other methods for making the applied metal composition integral or substantially integral with residual wall thickness 72 of substrate 30 include the use of flash lamps, with cooling and/or thermal insulation of other portions of blade 10 that should avoid being heat treated.

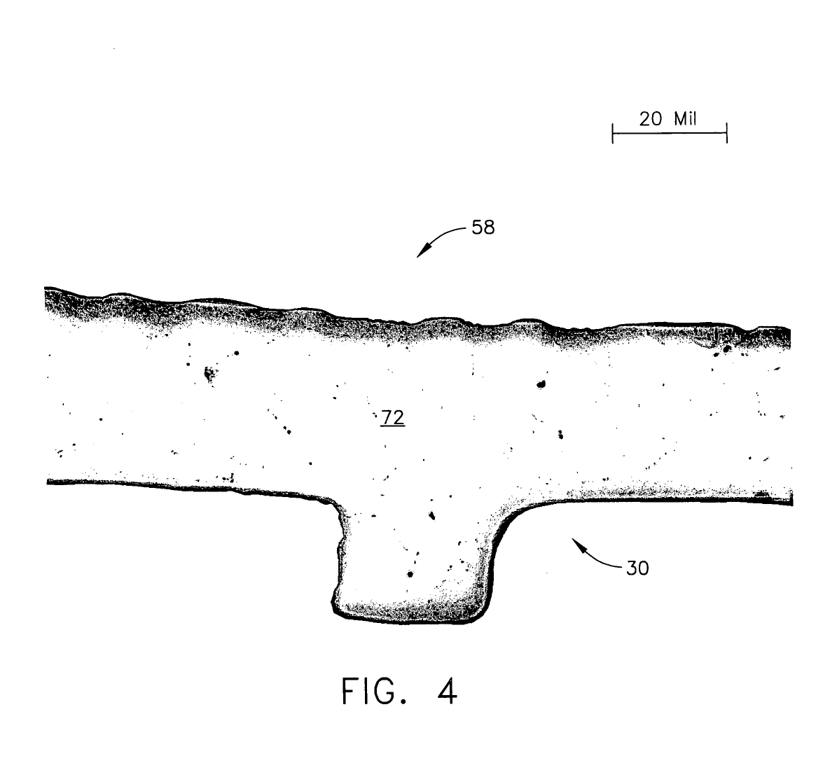

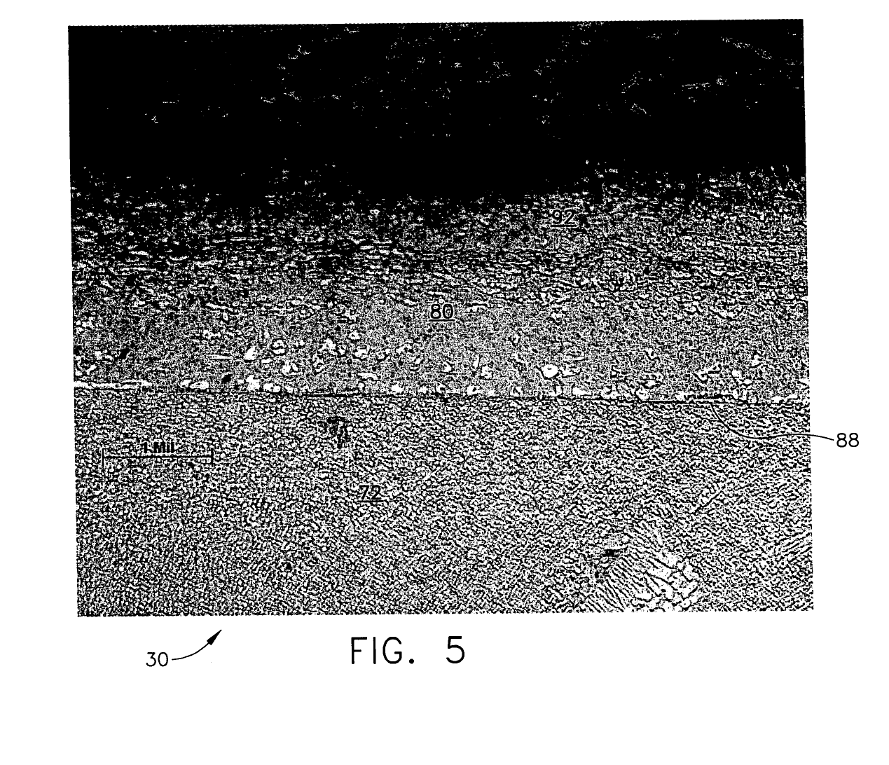

The images shown in FIGS. 4 and 5 illustrate the benefits of the embodiments of the method of this invention. FIG. 4 shows an airfoil 12 of a turbine blade 10 wherein metal substrate 30 comprises a Rene® 142 nickel-based metal alloy. As shown in FIG. 4, the diffusion coating 42, as well as a portion of the wall thickness (i.e., the removed wall thickness 58) has been removed from substrate 30, leaving the residual wall thickness 72. As shown in FIG. 5, a matching metal composition comprising the Rene® 142 nickel-based metal alloy is applied to residual wall thickness 72 by cathodic arc/ion plasma techniques and then treated by induction heating to form the restored wall thickness 80. This restored wall thickness 80 is essentially integral with the residual wall thickness 72, as shown by the faint boundary line indicated as 88. As also shown in FIG. 5, a coating 92 (which may or may not be a diffusion coating 42) is applied to and overlays restored wall thickness 80.

After the restored wall thickness 80 has been obtained by an embodiment of the method of this invention, diffusion coating 42 (or any other coating such as a bond coating, etc.) can reapplied by any appropriate diffusion coating technique. Suitable techniques for reapplying diffusion coating 42 include pack cementation, above pack, vapor phase, chemical vapor deposition (CVD) or slurry coating processes. See, for example, U.S. Pat. No. 4,148,275 (Benden et al.), issued Apr. 10, 1979 and U.S. Pat. No. 5,928,725 (Howard et al.), issued Jul. 27, 1999; and U.S. Pat. No. 6,039,810 (Mantkowski et al.), issued Mar. 21, 2000 (the relevant portions of each of which are incorporated by reference) for suitable CVD techniques. See, for example, See commonly assigned U.S. Pat. No. 5,759,032 (Sangeeta et al.), issued Jun. 2, 1998; U.S. Pat. No. 5,985,368 (Sangeeta et al.), issued Nov. 16, 1999; and U.S. Pat. No. 6,294,261 (Sangeeta et al.), issued Sep. 25, 2001 (the relevant portions of each of which are incorporated by reference) for suitable slurry-gel coating deposition techniques.

After reapplication of diffusion coating 42, a suitable TBC can be applied or reapplied to or over diffusion coating 42 if desired. The TBC can have any suitable thickness that provides thermal insulating properties. TBCs typically have a thickness of from about 1 to about 30 mils (from about 25 to about 769 microns), more typically from about 3 to about 20 mils (from about 75 to about 513 microns). The TBC can be formed on or over diffusion coating 42, by a variety of conventional thermal barrier coating methods. For example, TBCs can be formed by physical vapor deposition (PVD), such as electron beam PVD (EB-PVD), filtered arc deposition, or by sputtering. Suitable sputtering techniques for use herein include but are not limited to direct current diode sputtering, radio frequency sputtering, ion beam sputtering, reactive sputtering, magnetron sputtering and steered arc sputtering. PVD techniques can form TBCs having strain resistant or tolerant microstructures such as vertical microcracked structures. EB-PVD techniques can form columnar structures that are highly strain resistant to further increase the coating adherence. See, for example, U.S. Pat. No. 5,645,893 (Rickerby et al.), issued Jul. 8, 1997 (especially col. 3, lines 36-63) and U.S. Pat. No. 5,716,720 (Murphy), issued Feb. 10, 1998) (especially col. 5, lines 24-61) (all of which are incorporated by reference), which disclose various apparatus and methods for applying TBCs by PVD techniques, including EB-PVD techniques.

An alternative technique for forming TBCs is by thermal spray. As used herein, the term “thermal spray” refers to any method for spraying, applying or otherwise depositing the TBC that involves heating and typically at least partial or complete thermal melting of the ceramic material and depositing of the heated/melted ceramic material, typically by entrainment in a heated gas stream, on or over diffusion coating 42. Suitable thermal spray deposition techniques include plasma spray, such as air plasma spray (APS) and vacuum plasma spray (VPS), high velocity oxy-fuel (HVOF) spray, detonation spray, wire spray, etc., as well as combinations of these techniques. A particularly suitable thermal spray deposition technique for use herein is plasma spray. Suitable plasma spray techniques are well known to those skilled in the art. See, for example, Kirk-Othmer Encyclopedia of Chemical Technology, 3rd Ed., Vol. 15, page 255, and references noted therein, as well as U.S. Pat. No. 5,332,598 (Kawasaki et al.), issued Jul. 26, 1994; U.S. Pat. No. 5,047,612 (Savkar et al.) issued Sep. 10, 1991; and U.S. Pat. No. 4,741,286 (Itoh et al.), issued May 3, 1998 (the relevant portions of which are incorporated by reference) which describe various aspects of plasma spraying suitable for use herein, including apparatus for carrying out plasma spraying.

While specific embodiments of the this invention have been described, it will be apparent to those skilled in the art that various modifications thereto can be made without departing from the spirit and scope of this invention as defined in the appended claims.

What is claimed is:

1. A method comprising the following steps:
(a) providing a turbine component comprising an airfoil having a metal substrate with a wall thickness, wherein a portion of the wall thickness has been removed so as to provide a residual wall thickness;
(b) providing a metal composition that at least substantially matches that of the residual wall thickness; and
(c) applying the metal composition to the residual wall thickness such that the metal composition:
(1) is adhered to the residual wall thickness; and
(2) at least substantially restores the removed wall thickness.

2. The method of claim 1 wherein the turbine component provided in step (a) is a turbine blade or turbine vane.

3. The method of claim 1 wherein the residual wall thickness and metal composition each comprise a nickel-based alloy.

4. The method of claim 3 wherein the nickel-based alloy is high gamma-prime nickel alloy.

5. The method of claim 1 wherein step (c) is carried out by applying the metal composition to the residual wall thickness by using physical vapor deposition.

6. The method of claim 5 wherein step (c) is carried out by applying the metal composition to the residual wall thickness by using cathodic arc or ion plasma technique.

7. The method of claim 1 wherein step (c) is carried out such that the applied metal composition becomes integral or substantially integral with the residual wall thickness.

8. The method of claim 7 wherein step (c) is carried out by heat treating the applied metal composition so that it becomes integral with the residual wall thickness.

9. The method of claim 8 wherein step (c) is carried out by induction heating.

10. A method comprising the following steps:
(a) providing a previously repaired turbine component comprising an airfoil having a metal substrate with a wall thickness, wherein a portion of the wall thickness has been removed so as to provide a residual wall thickness;
(b) providing a metal composition that at least substantially matches that of the residual wall thickness; and
(c) applying the metal composition to the residual wall thickness such that the metal composition:
(1) is adhered to the residual wall thickness; and
(2) at least substantially restores the removed wall thickness.

11. The method of claim 10 wherein the turbine component provided in step (a) is a turbine blade or turbine vane.

12. The method of claim 10 wherein the residual wall thickness and metal composition each comprise a nickel-based alloy.

13. The method of claim 12 wherein the nickel-based alloy is high gamma-prime nickel alloy.

14. The method of claim 10 wherein step (c) is carried out by applying the metal composition to the residual wall thickness by using physical vapor deposition.

15. The method of claim 14 wherein step (c) is carried out by applying the metal composition to the residual wall thickness by using cathodic arc or ion plasma technique.

16. The method claim 10 wherein step (c) is carried out such that the applied metal composition becomes integral or substantially integral with the residual wall thickness.

17. The method of claim 16 wherein step (c) is carried out by heat treating the applied metal composition so that it becomes integral with the residual wall thickness.

18. The method of claim 17 wherein step (c) is carried out by induction heating.
